(19) United States
(12) Patent Application Publication
(10) Pub. No.: US 2018/0312955 A1
(43) Pub. Date: Nov. 1, 2018

(54) Flat Steel Product Having a Zn-Galvannealed Protective Coating, and Method for the Production Thereof

(71) Applicant: ThyssenKrupp Steel Europe AG, Duisburg (DE)

(72) Inventors: Karsten Machalitza, Muelheim (DE); Friedhelm Macherey, Alpen (DE); Klaus Uran, Moers (DE); Robert Yanik, Moers (DE); Michael Reckzeh, Essen (DE)

(21) Appl. No.: 15/764,396

(22) PCT Filed: Sep. 30, 2015
(86) PCT No.: PCT/EP2015/072634

§ 371 Date: Mar. 29, 2018

(51) Int. Cl. C23C 2/28; B32B 15/01; B32B 15/18; C21D 9/46; C22C 18/04; C21D 1/26; C21D 6/00; C22C 38/14; C22C 38/06; C22C 38/04; C22C 38/02; C22C 38/00; C23C 2/02; C23C 2/06; C23C 2/40; G01N 15/08

(52) U.S. Cl. CPC C23C 2/28; G01N 2015/086; B32B 15/18; C21D 9/46; C22C 18/04; C21D 1/26; C21D 6/005; C21D 6/008; C22C 38/14; C22C 38/06; C22C 38/04; C22C 38/02; C22C 38/002; C22C 38/001; C23C 2/02; C23C 2/06; C23C 2/40; G01N 15/08; B32B 15/013

(57) ABSTRACT

A flat steel product having a steel substrate and a protective coating having zinc as its main constituent that has been applied to the steel substrate by hot dip coating and produced by a subsequent galvannealing treatment, wherein the protective coating has pores on its free surface that extend into the protective coating. In the flat steel product, the proportions of right-skewed measurement traces determined in a topographic study are predominant over the proportion of non-right-skewed measurement traces both in the measurement direction and transverse to the measurement direction. Right-skewed measurement traces are determined by comparing the mean ascertained for each measurement trace with the median ascertained therefor. Those measurement traces where the mean is greater than the median are classified as being right-skewed.

The invention relates to a flat steel product having a steel substrate and having a protective coating having zinc as its main constituent that has been applied to the steel substrate by hot dip coating and produced a subsequent galvannealing treatment. This galvannealed Zn coating on the flat steel product has pores that reach into the coating at its surface.

The invention further relates to a method of producing such a flat steel product.

The invention additionally relates to a method of assessing the porosity of a Zn coating applied by hot dip coating to a flat steel product.

Where flat steel products are discussed here, what are meant thereby are rolled products in the form of sheet, strip, or (cut) blanks obtained therefrom.

Where alloying figures are given here, these are always based on weight, unless explicitly stated otherwise. Figures relating to the composition of atmospheres and the like, by contrast, are always based on the volume of the atmosphere in question, unless stated otherwise.

Flat steel products of the type in question here are used for the production of bodywork components for automobiles. This end use does not just give rise to high demands on mechanical properties, forming characteristics, weldability and paintability; high demands are also made on the visual appearance of the surfaces of the components formed from flat steel products of this kind.

In order to give the combinations of properties required, what are called IF (“IF”=“interstitial-free”) steels have been developed, which have particularly good forming properties, but are prone to corrosion in an aggressive environment to which they are exposed in practical use, being a bodywork component. IF steels are soft and ductile steels having only very small proportions of interstitial alloy elements, such as carbon or nitrogen. The low carbon content thereof is established in the steel production. In order to bind the carbon still present in the steel, IF steels may contain titanium and niobium, for example, as carbide formers. By controlled inclusion of manganese, silicon or phosphorus in the alloy, it is possible to achieve a distinct increase in tensile strength. The presence of silicon in IF steel affects the adhesion of the protective coating on the steel substrate.

In order to assure sufficient protection from corrosion, flat steel products consisting of IF steels are provided with metallic protective coatings that form a layer which is passive to the ambient oxygen and hence protect the steel substrate.

In the industrial sector, the protective coating can be applied to the steel substrate inexpensively and effectively by what is called “hot dip coating”. The steel substrate supplied as a flat product in the form of a strip or sheet undergoes a heat treatment in order to condition the steel substrate such that the protective coating applied subsequently adheres optimally thereon.

The steel substrate prepared in this way is then guided through a melt bath in a continuous procedure. The composition of the melt bath is adjusted such that the coating formed on the steel substrate by the hot dip coating can follow the deformations to which the flat steel product is subjected in the production of the component. The aim here is to minimize the risk of cracking, flaking and the like.

In order to improve the suitability for welding and the binding of the protective coating, flat steel products provided with a protective Zn coating, after the hot dip coating, can be subjected to a heat treatment in which interdiffusion of zinc and iron results in conversion of the applied zinc layer via a heat treatment to a zinc/iron alloy layer, abbreviated to “ZF coating” or protective “ZF” coating. This heat treatment is also referred to in technical jargon as “galvannealing”, and the flat steel products obtained as “galvannealed” flat steel products.

The iron content in the protective coating of galvannealed flat steel products has a positive effect on the electrode service life in welding. The rough, crystalline surface of the protective ZF coating additionally promotes paintability. However, the formability of galvannealed flat steel product is limited because the protective ZF coating contains brittle intermetallic phases that can form the starting point for cracks and flaking.

A particular problem is found to be the tendency of galvannealed flat steel products to attrition owing to the brittle intermetallic phases present in the ZF coating when such flat steel products are to be formed in a press to give components of complex shape. There is the risk here that acicular particles will become detached from the ZF coating (“powdering”) or that patches of coating will flake away (“flaking”). The patches here can become completely detached from the coating, or there can be cohesive detachment within the layer.

There have been various known attempts to improve the adhesion of Zn-based protective coatings on the respective steel substrate. A method intended to achieve this is known from JP 11-140587 A.

In the known method, first of all, a steel substrate is provided, which, in the three examples given JP 11-140587 A, contains (in % by weight) C contents of 0.002%, 0.003% and 0.01%, Mn contents of 0.1%, 0.2% and 1.0%, Si contents of 0.03%, 0.03% and 0.1%, Al contents of 0.03%, 0.03% and 0.04%, P contents of 0.01%, 0.05% and 0.07%, S contents of 0.008%, 0.008% and 0.003%, Ti contents of 0.03%, 0.04% and 0.06%, Nb contents of 0.003%, 0.007% and 0.01%, and B contents of 0.004%, 0.006% and 0.010%, the balance in each case being iron and unavoidable impurities. The steel substrate is annealed under an H₂—N₂ atmosphere containing 5% by volume of H₂ and having a dew point of not more than −20° C. at an annealing temperature of 800-850° C. Subsequently, it is cooled down to a bath inlet temperature of 475° C. and then guided through a melt bath containing 0.14% by weight of Al, the balance being zinc and unavoidable impurities. The flat steel product provided with the Zn hot dip coating that exits from the melt bath then undergoes a heat treatment in which it is annealed at a temperature of 480-540° C. to form a ZF alloy layer. In the case of a flat steel product provided with a protective ZF coating which has been produced in this way, the intention is to improve the adhesion of the coating on the respective steel substrate, such that flaking and cracks in the coating are avoided.

Against the background of the prior art elucidated above, it is an object of the invention to provide a flat steel product having optimal formability and further improved characteristics in the case of cold forming in a cold-forming tool.

In addition, a method of producing flat steel products of this kind was to be specified.

Finally, a method that permits simple and reliable assessment of the porosity of the surface of a galvannealed Zn coating of a flat steel product with respect to the powdering characteristics of the galvannealed Zn coating was also to be provided.

In relation to the flat steel product, this object has been achieved in that a flat steel product of this kind has the features specified in claim 1.

A method that achieves the aforementioned object is specified in claim 8.

With regard to the method of assessing the porosity of a galvannealed Zn coating on a flat steel product, the abovementioned object has been achieved in accordance with the invention by the method specified in claim 10.

Advantageous configurations of the invention are specified in the dependent claims and are elucidated individually hereinafter, as is the general concept of the invention.

A flat steel product of the invention, in accordance with the prior art elucidated at the outset, comprises a steel substrate and a protective coating which has been applied to the steel substrate by hot dip coating and subjected to a subsequent galvannealing treatment. The main constituent of the protective coating is zinc. This protective coating has pores on its free surface that extend into the protective coating.

According to the invention, the proportions of right-skewed measurement traces determined in a topographic study are predominant over the proportion of non-right-skewed measurement traces both in measurement direction and transverse to measurement direction, wherein the right-skewed measurement traces are determined in that a measurement collective of at least 10 000 measurements is captured in each case in a square surface section having an edge length of 1 mm for at least 400 parallel measurement traces, the mean and the median are ascertained for each of the measurement collectives captured in measurement direction and transverse to measurement direction, the mean ascertained for each measurement trace is compared with the median ascertained therefor and those measurement traces where the mean is greater than the medium are classified as being right-skewed.

It has been found that, surprisingly, given a sufficiently high proportion of pores in the total area of the coating layer, the tendency to dust formation (“powdering”) by fine particles which could become detached from the protective ZF coating, present on the steel substrate after the galvannealing treatment, of the flat steel product of the invention, and to flaking of larger patches away from the protective ZF coating (“flaking”) is distinctly reduced. Accordingly, in a flat steel product of the invention, the risk of formation of cracks is also low when a flat steel product of the invention is subjected to complex forming in a cold forming process. Thus, the protective coating having the characteristics of the invention can also follow deformations about the narrowest radii without being subject to lasting damage to the coating.

This is achieved in that, in accordance with the invention, so many pores are provided in the protective coating that, when the flat steel product is bent about a tight radius, the material of the protective coating between the pores on the inside of the bend can occupy the free space offered by the pores, such that there are only minimized compressive stresses on the inside of the bend owing to the material compression that inevitably occurs there. On the outside of the bend, the material of the protective coating, by contrast, can spread out owing to the interruptions brought about by the pores in the manner of a fan, such that the tensile stresses that inevitably occur there as a result of the material stretching are likewise minimized.

In practice, a rule of thumb is that galvannealed Zn coatings in which the opening areas of the pores occupy a total of at least 10% of the area of the free surface of the protective coating have noticeably improved powdering characteristics on forming in a forming tool.

With the characteristic feature of the provisions specified in claim 1 and repeated above, it is reliably possible to identify those flat steel products provided with a galvannealed Zn coating which can be expected to have a tendency only to minimal powder formation on deformation.

According to the invention, for assessment of whether a surface has sufficient porosity for the purposes of the invention, a square surface of side length 1 mm is analyzed. At least 10 000 measurements are captured on each of the more than 400 parallel measurement traces measured for the purpose. The profile data thus obtained can be recorded, for example, in the form of a table that can be processed by data processing, which forms the basis for the further evaluations. The assessment method of the invention proceeds from the finding that, in a porous surface, the distribution of the measurement values in a trace has a distinct right-skewness, i.e. has a peak of the distribution shifted to the negative by values in the negative range. An insufficiently porous surface, by contrast, does not have any significant skewness. On the basis of this observation, in accordance with the invention, a measurement collective of at least 10 000 measurements for at least 400 parallel-aligned measurement traces of the surface under consideration in each case is captured in a square surface section of the Zn coating, the surface section under consideration having an edge length of 1 mm.

Then the median and the mean of the measurements of each measurement collective are determined in measurement direction and transverse to measurement direction, in each case considering only those measurement traces for which the mean is greater than the median to be right-skewed.

Subsequently, the proportions of the right-skewed measurement traces of all measurement traces in measurement direction and transverse to measurement direction are determined.

Finally, the proportions of the right-skewed measurement traces in measurement direction and transverse to measurement direction are each compared to a limit of at least 60%, and a surface of the Zn coating in which the proportions of the right-skewed measurement traces both in measurement direction and transverse thereto correspond at least to the limit are considered to be porous, whereas samples in which either the proportion of right-skewed measurement traces in measurement direction or the proportion of right-skewed measurement traces transverse to measurement direction is below the limit are considered to be nonporous.

The invention thus examines, as the criterion for the assessment of whether there is a right-skewed distribution, whether the mean of the measurements of a measurement trace is greater than the median. In the case of a right-skewed distribution, as is known per se, it is the case that “mean>median”, whereas, in the case of a left-skewed distribution, it is the case that “mean<median”. This criterion can be enhanced by also considering the mode of the measurement data set under consideration in each case. In that case, for a right-skewed distribution, as is likewise known per se, it is the case that “mean>median>mode”, whereas, in the case of a left-skewed distribution, it is the case that “mean<median<mode” (https://de.wikipedia.org/wiki/Schiefe_(Statistik)).

By the method of the invention, very good distinction is possible between porous and nonporous trace collectives in the two directions (measurement direction and transverse thereto). If the proportion of right-skewed traces is predominant for both measurement directions, and is especially at least 60%, good powdering characteristics can be assumed. The higher the proportion of right-skewed traces, the lower the formation of powder by attrition on forming. Accordingly, Zn-galvannealed coated flat steel products suitable for the purposes of the invention are especially those in which the proportion of right-skewed measurement traces in measurement direction is at least 70% and the proportion of right-skewed measurement traces transverse to measurement direction is at least 80%.

As a result, the protective coating of a flat steel product of the invention, by virtue of the pores envisaged in accordance with the invention, thus becomes able, even though its constitution is brittle per se, on forming, to react in the manner of a spongelike material which can move away in the event of compression by virtue of reduction of the size of its pores, and can retreat in the event of lengthening by virtue of deformation of the pores.

In principle, the invention is suitable for any flat steel product envisaged for cold forming wherein the steel substrate has been provided with a galvannealed protective coating. However, the invention is found to be particularly effective in the case of flat steel products wherein the steel substrate consists of a soft IF steel. In this context, all known steel compositions that are typically used for the production of flat steel products which are subjected to hot dip coating with a zinc-based protective coating and then to a galvannealing treatment are useful.

For the production of the steel substrate of a flat steel product of the invention, examples of useful steels include those which consist (in % by weight) of up to 0.05% C, up to 0.2% Si, 0.5-0.18% Mn, up to 0.02% P, up to 0.02% S, 0.01-0.06% Al, up to 0.005% N, 0.02-0.1% Ti, up to 0.0005% B, the balance being iron and technically unavoidable impurities.

Another alloy specification for the production of the steel substrate of a flat steel product of the invention which is particularly suitable for the purposes of the invention and is based on the combined presence of Ti and Nb is (in % by weight): up to 0.2% C, up to 0.5% Si, up to 1.5% Mn, up to 0.02% P, up to 0.01% S, up to 0.1% Al, 0.01-0.03% Nb, up to 0.005% N, 0.02-0.08% Ti, up to 0.0007% B, the remainder being iron and unavoidable impurities.

Across the range of steel types, continuous coatings having a high iron content give worse results in adhesion testing than porous coatings having a low iron content. With rising silicon content in the IF steel, there is a decrease in the tendency to adhesive flaking. The occurrence of near-surface silicon is crucial for the adhesion of the ZF coating. An Si-containing IF steel regularly shows good adhesion properties even independently of the dew point. In the case of low-Si IF steel, there is an improvement in the adhesion test results with falling dew point, since silicon is enriched externally here. The good flaking characteristics of the protective ZF coating having the characteristics of the invention on an IF substrate with rising silicon content are connected to the formation of a directed and square-edged substrate microstructure, the serration. If steel substrates based on an IF steel having a low Si content are used, no such typical serrated structure is achieved. Therefore, the Si contents of the steel substrates of flat steel products of the invention are preferably within the range specified above.

The Al content in the zinc bath has a crucial influence on the intermetallic alloy layer formation. The higher the concentration of aluminum in the zinc bath, the weaker and slower the reaction of iron and zinc that takes place.

This can be utilized for control of the degree up to which alloying with iron through the protective galvannealed coating advances within the time available for the heat treatment. It may be advantageous here when the Al content of the melt bath used for the hot dip coating is adjusted such that the protective coating in the finished flat steel product of the invention (in % by weight) is up to 0.15% by weight of Al, especially in the range of 0.1-0.15, where up to 0.5% by weight of Fe may additionally be present in the melt bath.

Irrespective of which additional alloy elements are present, the balance of the protective coating always consists of Zn and unavoidable impurities from the production.

Typically, in a flat steel product of the invention, the thickness of the protective coating is up to 10 μm, especially 6.5-10 μm.

The pores present in accordance with the invention in the surface of the protective coating may be in any distribution.

By virtue of the area of the surface of the protective coating of a flat steel product of the invention occupied by the opening cross sections of the pores having a proportion of at least 10%, it is possible to ensure that sufficient space is available in each case between the material of the protective coating that bounds the pores from one another in the manner of fillets in order to absorb excess material from the protective coating in the event of material compression.

The method of the invention enables production of flat steel products of the invention on the industrial scale in an operationally reliable manner.

For this purpose, in the method of the invention of producing a flat steel product comprising a steel substrate prefabricated as a flat product and a galvannealing protective coating having Zn as its main constituent that has been applied thereto, the following steps are envisaged:
providing the steel substrate,
recrystallization annealing of the steel substrate at an annealing temperature of 800-850° C. under an N₂- and H₂-containing annealing atmosphere having a dew point of −40° C. to −20° C.,
cooling the recrystallizingly annealed substrate to a bath inlet temperature of 440-480° C.,
hot dip coating the steel substrate with the protective coating by passing the cooled steel substrate through a melt bath consisting of Zn or a Zn alloy,
heat treatment of the flat steel product obtained after the hot dip coating at an annealing temperature of 500-570° C., in order to obtain the galvannealing protective coating,
and
cooling the flat steel product obtained after the heat treatment to room temperature.

A factor of particular significance in the production of a protective coating having pores in accordance with the invention is the annealing atmosphere under which the recrystallization annealing conducted for preparation of the hot dip coating is performed. The dew point established in the annealing gas atmosphere in the recrystallization annealing affects the oxidation characteristics of the alloy elements. Thus, in the case of a low partial oxygen pressure, at a dew point of not lower than −20° C., especially not lower than −40° C., there is increased external enrichment of the diffusion-capable alloy elements. This promotes the pore formation which is the aim of the invention in the protective coating, since there is increased formation of pores on grain surfaces where reaction is slow.

IF steels having a low Si content have the highest oxide coverage of the grain surfaces of the first grain layer here at a low dew point of down to −40° C. By contrast, a higher dew point of −5° C. or more leads to internal element enrichment, such that the visible grain boundaries and grain surfaces of the first grain layer have a low level of oxide coverage.

A texture study shows that the recrystallization characteristics of low-Si IF steels is likewise controlled by the setting of the dew point. The particle size decreases slightly with rising dew point, whereas the frequency of the recrystallized grains increases with rising dew point.

The inventive manner of conditioning the near-surface microstructure of the steel substrate of a flat steel product of the invention by the setting of a predefined dew point has a direct effect on the alloy characteristics of the zinc coating. After the galvanization, the coating is composed for the most part of pure zinc and a proportion of intermetallic iron-zinc phases. The proportion of these phases increases with rising dew point, which is attributable to the internal oxidation of the alloy elements, which leads to a high reactivity of the surface.

In the case of steels having a high silicon content, the alloy layer reaction takes place in a retarded manner compared to the lower-alloyed steel.

The bath inlet temperature at which the steel substrate enters the melt bath is typically adjusted such that the entering steel substrate does not result in any cooling of the melt bath. For this purpose, it is possible to use bath inlet temperatures of 450-470° C. that are customary in practice.

The invention is elucidated in detail hereinafter with reference to working examples. The figures show:

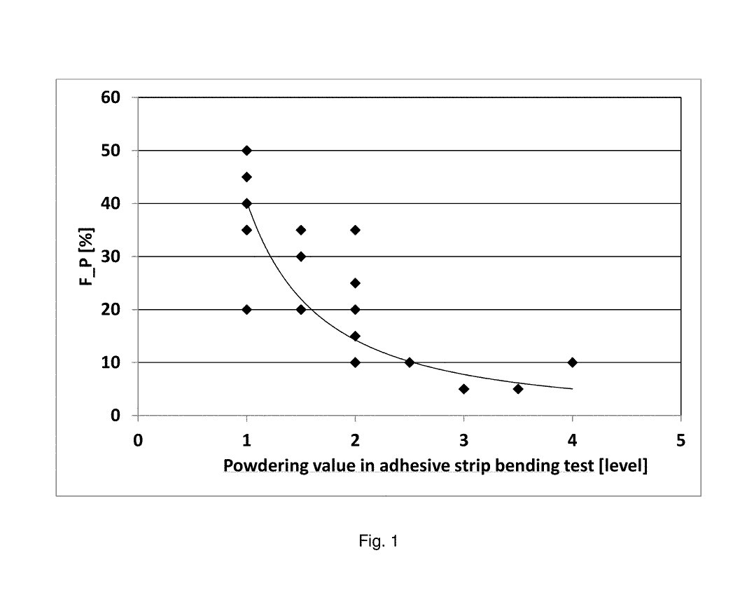

FIG. 1 a diagram in which the percentage area proportion of the pore openings is plotted against the result of an adhesive strip bending test;

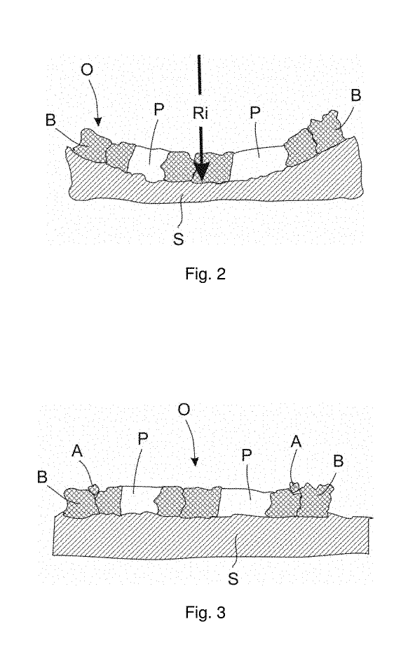

FIG. 2 a section of a bent sample of a flat steel product of the invention in a schematic diagram;

FIG. 3 the section of the sample according to FIG. 2 with flat alignment of the flat steel product in a schematic diagram;

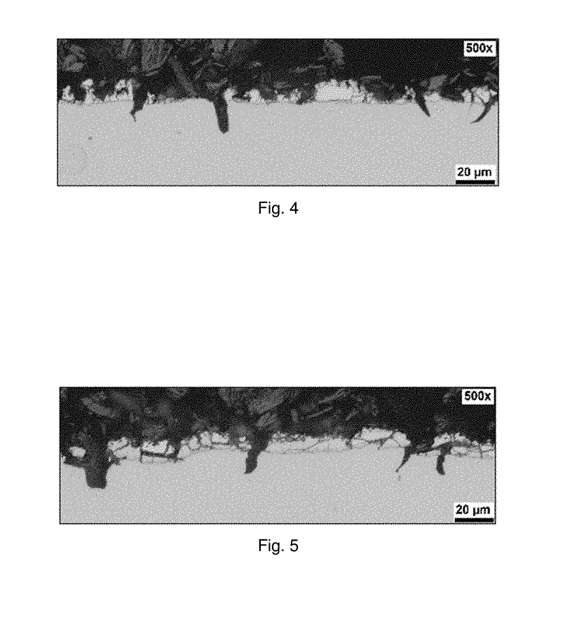

FIG. 4 a detail from a transverse section of a sample of the invention;

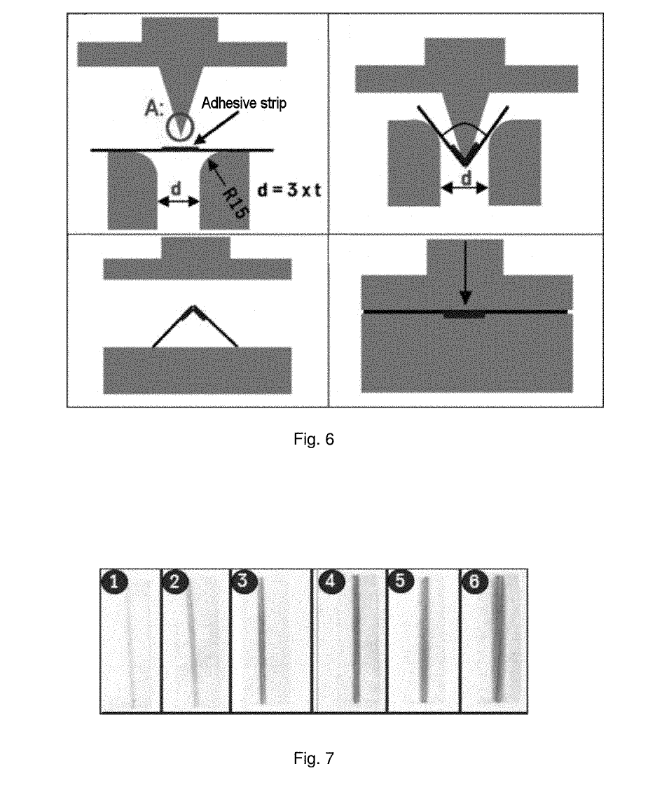

FIG. 5 a detail from a transverse section of a sample not in accordance with the invention;

FIG. 6 a diagram showing the principle of the adhesive strip test, on the basis of which the powdering values reported in the diagram according to FIG. 1 have been ascertained;

FIG. 7 a diagram of a standard series for assessment of the powdering characteristics of samples examined by the adhesive strip test;

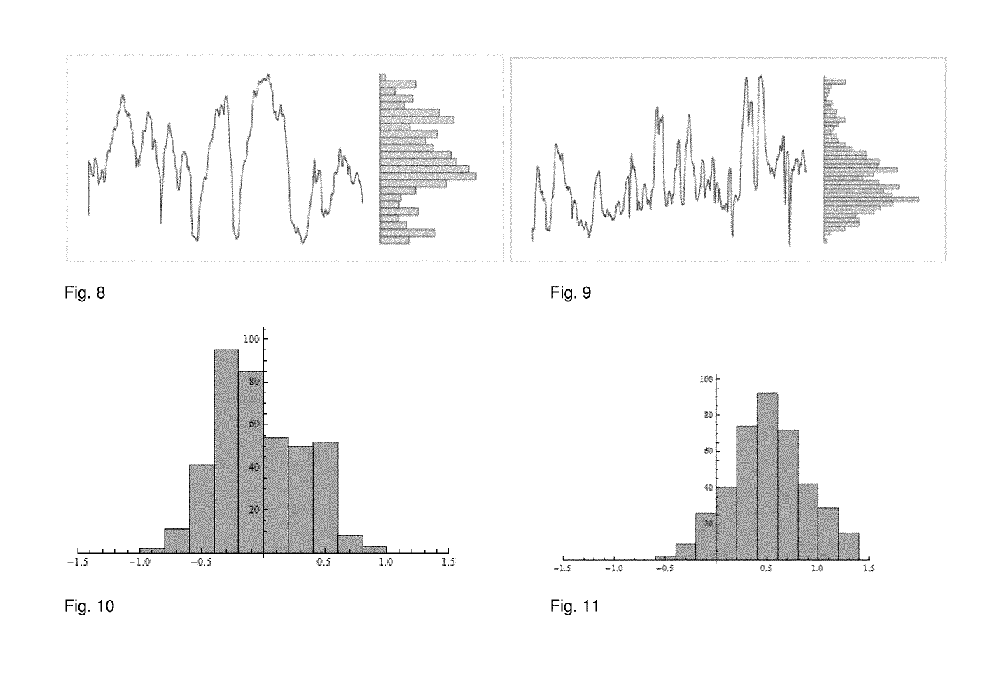

FIG. 8 a diagram having a typical trace for a nonporous sample;

FIG. 9 a diagram having a typical trace for a porous sample;

FIG. 10 histogram of the v values for a nonporous sample;

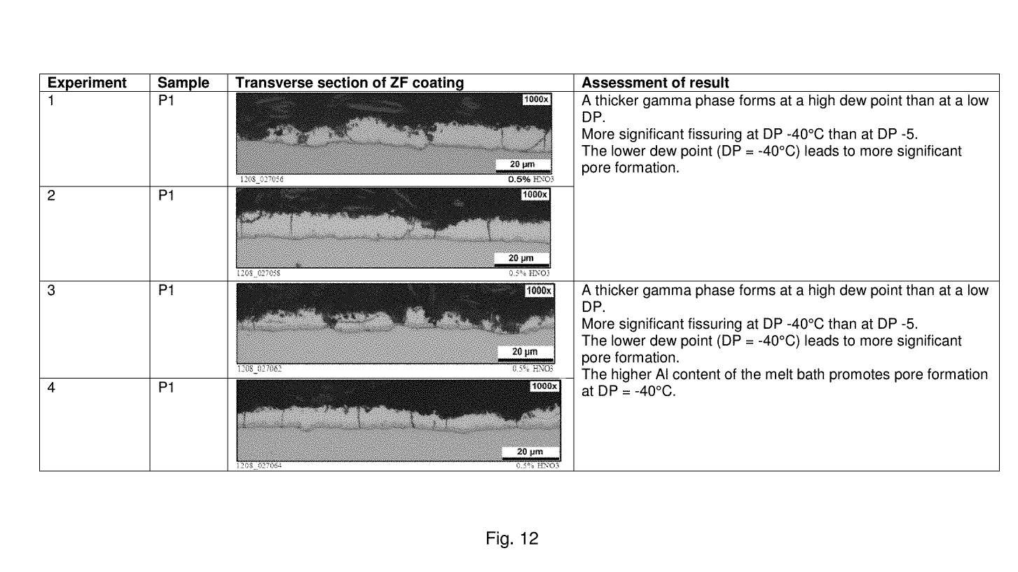

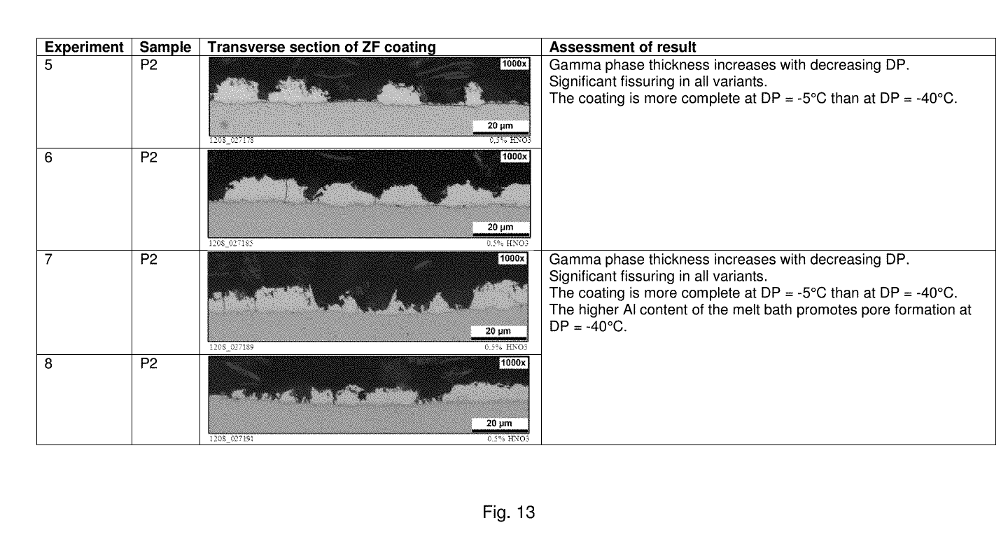

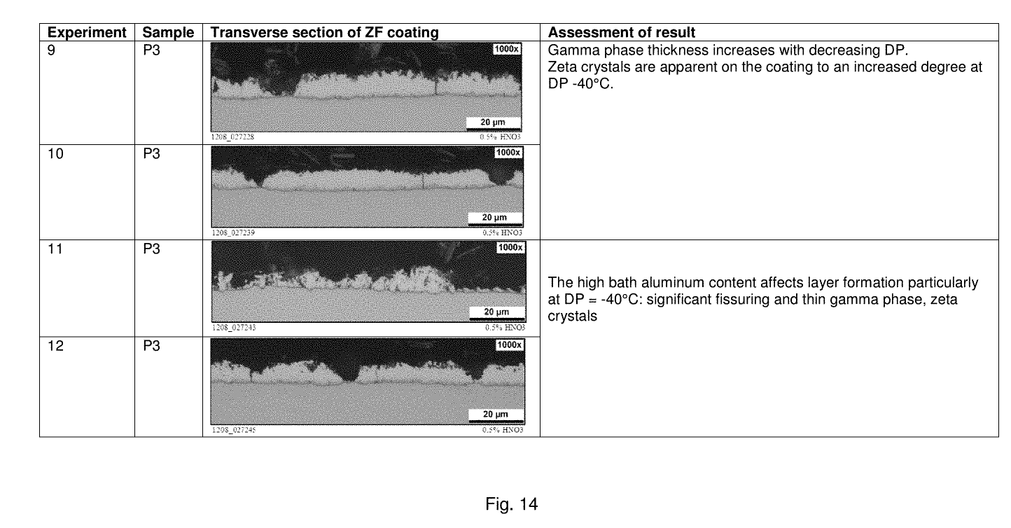

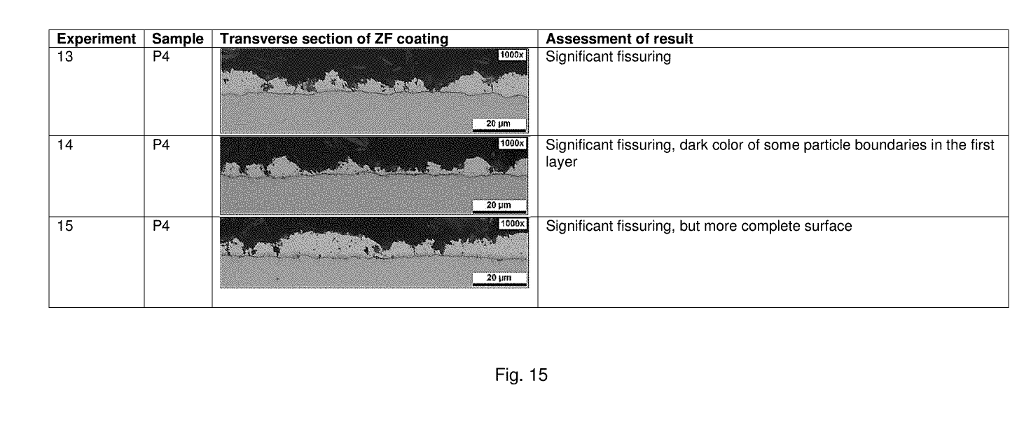

FIG. 11 histogram of the v values for a porous sample.

Samples P1, P2, P3, P4 of steel substrates in the form of sheets having the compositions specified in table 1 have been subjected, in a continuous process procedure, first to a recrystallization annealing at an annealing temperature T_rg over a duration t_rg under an N₂—H₂ annealing atmosphere with a dew point DP under the conditions specified in table 2.

Subsequently, samples P1-P4 have been cooled down to a bath inlet temperature Te, with which they have been guided for hot dip coating into a melt bath kept at a bath temperature Tb, which in each case had a particular Al content and consisted, as the balance, of Zn and unavoidable impurities.

The samples P1-P4 exiting from the melt bath have finally been subjected to a galvannealing treatment in which they have been kept at a temperature T_G over a duration t_G, in order to produce a galvannealed protective coating on the steel substrate of the respective flat steel product sample P1-P4.

After they have cooled down to room temperature, the samples have been assessed with regard to the extent of the protective coating. The results of this assessment are compiled in tables 3a-3d.

Subsequently, the samples P1-P4 have been subjected to an adhesive strip bending test. Specifically, this test is described in the publication “Überzugsbeurteilung von in Linie erzeugtem ZF-Feinblech” [Assessment of Coatings On Line-Produced Thin ZF Sheet] published by ThyssenKrupp Steel Europe AG, Werkstoffkompetenzzentrum, ABW, 2006, Bde. A-ME-5451-A.

The adhesive strip bending test is a test method for determination of powdering characteristics. This test method simulates mechanical stress on the material by compression-bending stress, which is customary for pressed components during the forming process.

The bending apparatus consists of a pair of rolls and a bending mandrel, in order to undertake three-point bending in the roll nip. The distance between the two rolls corresponded to three times the thickness of the test sheet in the examination of samples P1-P4.

The top side of the sample was provided with a conventional adhesive tape available under the “TESA-Film 4104” trade name.

The samples P1-P4 were inserted into the apparatus the test side facing upward (FIG. 6, image 1) and bent by 90° with the bending mandrel from above (FIG. 6, image 2). This was followed by the unbending of the sample with the aid of a flat die (FIG. 6, images 3-4).

The adhesive strip was pulled off and stuck to a white sheet for assessment. The particles that have broken out of the coating layer as a result of the forming stress stick to the adhesive tape. These have a matte gray to black appearance on the white sheet.

Attrition was assessed visually without assistance using a standard series divided into 6 levels (FIG. 7). Level 1 has the lowest particle detachment; barely any attrition is apparent here, i.e. the powdering characteristics are optimal. Up to level 6, the amount of attrition rises in equal stages, such that there is the most attrition at level 6 and hence the worst powdering characteristics.

Samples having powdering characteristics which can be assigned with level 1 or 2 are suitable for use in the automotive industry.

FIGS. 2 and 3 illustrate the effect of the pores P which are present in accordance with the invention in the surface O of a flat steel product provided with a protective Zn coating B on its steel substrate S. By virtue of the material of the protective coating B that surrounds the pores P on the inside of a bend by a bending radius Ri being able to yield into the free spaces formed by the pores P, much lower compressive stress arises in the protective coating than in the case of a continuous pore-free protective coating. Accordingly, much fewer powder particles A break out of the protective coating B when the sample is unbent back into its flat original state (FIG. 3).

FIG. 4 shows a detail from a transverse section of the inventive sample P2 after the adhesive strip bending test.

For comparison, FIG. 5 shows a detail of a transverse section of a sample V that has likewise been produced on the basis of sample P2, but has been subjected to recrystallization annealing not in accordance with the invention under an annealing atmosphere having a dew point of −5° C. after the adhesive bending test.

It is found that, in the case of the inventive sample (FIG. 4), there are relatively few fracture sites present, whereas there is increased occurrence of fracture sites in the noninventive sample.

For samples P1-P4, the proportion of pores in the total area under consideration in each case has been detected and plotted in FIG. 1 against the respective results from the adhesive strip bending test. It is found that, given sufficiently great area components F_P of the pores corresponding to the provisions of the invention, which each attain levels 1 and 2 for the powdering characteristics of the samples P1-P4 that are sufficient for automotive applications.

Diagram 1 demonstrates that, over and above a proportion F_P of the areas of the pore openings of 10%, a distinct reduction in the powdering value is established.

For assessment of the porosity, for example, in experiments 1 and 2, test samples P1′, P1″ obtained from the samples P1 are subjected to a topographic study. For this purpose, a square surface having side length 1 mm of the flat steel product coated with a galvannealed Zn coating was analyzed. 10 000 measurements were captured on each of the 401 parallel traces analyzed. The profile data thus obtained were provided in the form of a table processible by data processing by standard programs.

The first visual assessment of the traces showed that there are clearly visible differences between the profiles of the porous sample and the nonporous sample. While the nonporous sample 1″ shows a nearly symmetrical profile with comparable highs and lows (FIG. 8), broad but fissured valleys are apparent in almost all traces of the porous sample P′ (FIG. 9), while the peaks are comparatively narrow and clearly delimited from one another. To the right alongside the profile lines, FIGS. 8 and 9 depict the corresponding histogram of the profile in question. It is apparent that the distribution of the measurements in a trace of the porous sample has distinct right-skewness (frequency of the values in their negative range, peak of the distribution is shifted to the negative). The nonporous sample, by contrast, has no significant skewness.

Subsequently, for description of the skewed distributions, mean, median and mode of the values for the measurement traces have been compared.

For this purpose, for the measurement collective under consideration here (measurement collective of sample P1′ in measurement direction and transverse to that, measurement collective of sample P1″ in measurement direction and transverse to that), the mean, the median and the mode have been determined for each measurement trace. It has been found that, in the porous sample, as expected, there is a distinct cluster of right-skewed distributions in measurement direction and transverse to that, whereas, for the nonporous sample, this was the case only in the position rotated by 90° relative to the original measurement. Table 4 summarizes the results of the measurements.

By this method, good distinction between the porous and nonporous trace collectives in both direction is possible. Moreover, in this assessment, the porous sample in measurement direction also has greater significance than the nonporous sample transverse to measurement direction.

Alternatively, the above requirement can be weakened by leaving the mode unconsidered and using only the “mean>median” configuration for the assessment of the sample. Given identical breakdown of the collectives as above, the results that can be inferred from table 5 are then found.

Overall, in the alternative method, all the percentages ascertained are higher, which is of course clear since merely one boundary condition has been dropped. Otherwise, there is not much change in the ratios of the percentages. However, a clear difference from the above assessment with the mode is that all 10 000 “traces” fulfill the “mean>median” condition in the 90° position. Overall, it is apparent that only the porous sample in both test directions has distinct right-skewness across all traces, whereas this is the case for the nonporous sample only transverse to measurement direction.

TABLE 1

| Sample | C | Si | Mn | P | S | Al | N | Ti | B |
|---|---|---|---|---|---|---|---|---|---|
| P1 | 0.0017 | 0.003 | 0.1 | 0.008 | 0.005 | 0.026 | 0.0022 | 0.07 | 0.0002 |
| P2 | 0.0016 | 0.023 | 0.12 | 0.008 | 0.006 | 0.029 | 0.0021 | 0.046 | 0.0002 |
| P3 | 0.0026 | 0.072 | 0.12 | 0.007 | 0.006 | 0.026 | 0.0029 | 0.073 | 0.0002 |
| P4 | 0.174 | 0.418 | 1.49 | 0.017 | 0.002 | 0.041 | 0.0047 | 0.017 | 0.0005 |

Figures in % by weight, balance: iron and unavoidable contamination

TABLE 2

| | | | | | | | Al | | |
|---|---|---|---|---|---|---|---|---|---|
| | | | | | | | content | | |
| Experi- | Sam- | DP | T_rg | t_rg | Te | Tb | [% by | T_G | t_G |
| ment | ple | [° C. ] | [° C. ] | [s] | [° C. ] | [° C. ] | wt. ] | [° C. ] | [s] |
| 1 | P1 | −40 | 795 | 114 | 474 | 470 | 0.100 | 450 | 13 |
| 2 | P1 | −5 | 795 | 114 | 474 | 470 | 0.100 | 450 | 13 |
| 3 | P1 | −40 | 795 | 114 | 474 | 470 | 0.140 | 450 | 13 |
| 4 | P1 | −5 | 795 | 114 | 474 | 470 | 0.140 | 450 | 13 |
| 5 | P2 | −40 | 795 | 114 | 474 | 470 | 0.100 | 450 | 13 |
| 6 | P2 | −5 | 795 | 114 | 474 | 470 | 0.100 | 450 | 13 |
| 7 | P2 | −40 | 795 | 114 | 474 | 470 | 0.140 | 450 | 13 |
| 8 | P2 | −5 | 795 | 114 | 474 | 470 | 0.140 | 450 | 13 |
| 9 | P3 | −40 | 795 | 114 | 474 | 470 | 0.100 | 450 | 13 |
| 10 | P3 | −5 | 795 | 114 | 474 | 470 | 0.100 | 450 | 13 |
| 11 | P3 | −40 | 795 | 114 | 474 | 470 | 0.140 | 450 | 13 |
| 12 | P3 | −5 | 795 | 114 | 474 | 470 | 0.140 | 450 | 13 |
| 13 | P4 | −5 | 795 | 114 | 474 | 470 | 0.100 | 450 | 13 |
| 14 | P4 | −20 | 795 | 114 | 474 | 470 | 0.100 | 450 | 13 |
| 15 | P4 | −40 | 795 | 114 | 474 | 470 | 0.100 | 450 | 13 |

TABLE 4

| | | | | Proportion | |
|---|---|---|---|---|---|
| | | | Number | of | In |
| | | Number | of | right-skewed | accordance |
| | | of | non- | traces in the | with |
| | | right-skewed | right-skewed | sum total | the |
| Sample | Traces in | traces | traces | of the traces | invention? |
| P1′ | Measurement direction | 120 | 281 | 30% | NO |
| P1′ | Transverse to | 6476 | 3524 | 65% | |
| | measurement direction | | | | |
| P1″ | Measurement direction | 298 | 103 | 74% | YES |
| P1″ | Transverse to | 8720 | 1280 | 87% | |
| | measurement direction | | | | |

TABLE 5

| | | | | Proportion | |
|---|---|---|---|---|---|
| | | | Number | of | In |
| | | Number | of | right-skewed | accordance |
| | | of | non- | traces in the | with |
| | | right-skewed | right-skewed | sum total | the |
| Sample | Traces in | traces | traces | of the traces | invention? |
| P1′ | Measurement direction | 145 | 256 | 36% | NO |
| P1′ | Transverse to | 8299 | 1701 | 83% | |
| | measurement direction | | | | |
| P1″ | Measurement direction | 356 | 45 | 89% | YES |
| P1″ | Transverse to | 10000 | 0 | 100% | |
| | measurement direction | | | | |

1. A flat steel product having a steel substrate and a protective coating having zinc as its main constituent applied to the steel substrate by hot dip coating and produced by a subsequent galvannealing treatment, wherein the protective coating has pores on its free surface that extend into the protective coating, wherein proportions of right-skewed measurement traces determined in a topographic study are predominant over a proportion of non-right-skewed measurement traces both in a measurement direction and transverse to the measurement direction, wherein the right-skewed measurement traces are determined for a square surface section having an edge length of 1 mm by capturing at least 10,000 measurements for each of at least 400 parallel measurement traces, wherein a mean traces and a median are ascertained for each of the measurement captured in the measurement direction and transverse to the measurement direction, wherein the mean ascertained for each measurement trace is compared with the median ascertained therefor and the measurement traces where the mean is greater than the median are classified as being right-skewed measurement traces.

2. The flat steel product as claimed in claim 1, wherein on evaluation in the measurement direction, the proportion of the right-skewed traces is at least 60% of all traces.

3. The flat steel product as claimed in claim 1, wherein on evaluation, transverse to the measurement direction, the proportion of the right-skewed traces is at least 60% of all traces.

4. The flat steel product as claimed in claim 1, wherein the steel substrate is manufactured from an interstitial free (IF) steel.

5. The flat steel product as claimed in claim 1, wherein the steel substrate comprises (in % by weight) up to 0.05% C, up to 0.2% Si, 0.5-0.18% Mn, up to 0.02% P, up to 0.02% S, 0.01-0.06% Al, up to 0.005% N, 0.02-0.1% Ti, up to 0.0005% B, the balance being iron and technically unavoidable impurities.

6. The flat steel product as claimed in claim 1, wherein the steel substrate comprises (in % by weight) up to 0.2% C, up to 0.5% Si, up to 1.5% Mn, up to 0.02% P, up to 0.01% S, up to 0.1% Al, 0.01-0.03% Nb, up to 0.005% N, 0.02-0.08% Ti, up to 0.0007% B, the balance being iron and unavoidable impurities.

7. The flat steel product as claimed in claim 1, wherein a thickness of the protective coating is up to 10 μm.

8. A method of producing a flat steel product comprising a steel substrate prefabricated as a flat product and a galvannealed protective coating having Zn as its main constituent applied thereto, comprising the steps of:
providing the steel substrate;
recrystallization annealing of the steel substrate at an annealing temperature of 800-850° C. under an N₂- and H₂-containing annealing atmosphere having a dew point of −40° C. to −20° C.
cooling the annealed substrate to a bath inlet temperature of 440-480° C.,
hot dip coating the steel substrate with the a protective coating by passing the cooled steel substrate through a melt bath consisting of Zn or a Zn alloy;
heat treating of the flat steel product obtained after the hot dip coating at an annealing temperature of 500-570° C., in order to obtain the galvannealed protective coating;
and
cooling the flat steel product obtained after the heat treatment to room temperature.

9. The method as claimed in claim 8, wherein the melt bath comprises 0.1-0.15% by weight of Al and up to 0.5% by weight of Fe, the balance being zinc and unavoidable impurities.

10. A method of assessing the porosity of a surface of a flat steel product coated with a galvannealed Zn coating, comprising the steps of:
capturing a measurement collective of at least 10,000 measurements in each case for at least 400 parallel-aligned measurement traces in a square surface section of the Zn coating, wherein the square surface section has an edge length of 1 mm;
determining mean and a median of the measurements of each measurement collective in a measurement direction, considering only the measurement traces for which the mean is greater than the median to be right-skewed;
determining a mean and a median of the measurements of each measurement collective transverse to he measurement direction, considering only the measurement traces for which the mean is greater than the median to be right-skewed;
determining a proportion of right-skewed measurement traces in all measurement traces in the measurement direction;
determining a proportion of right-skewed measurement traces in all measurement traces transverse to the measurement direction;
comparing the proportion of the right-skewed measurement traces in the measurement direction and the proportion of right-skewed measurement traces transverse to the measurement direction, considering a surface of the Zn coating in which the proportions of the right-skewed measurement traces both in the measurement direction and transverse thereto are at least 60% to be porous, whereas samples in which either the proportion of right-skewed measurement traces in the measurement direction or the proportion of the right-skewed measurement traces transverse to the measurement direction are below 60% are considered to be nonporous.
